(19) United States
(12) Patent Application Publication
(10) Pub. No.: US 2013/0134751 A1
(43) Pub. Date: May 30, 2013

(54) Two-Way Zipper Closeout for Folding Head Restraint Slots

(71) Applicants: Sai Prasad Jammalamadaka, Novi, MI (US); Ronald L. Miotto, Redford, MI (US)

(72) Inventors: Sai Prasad Jammalamadaka, Novi, MI (US); Ronald L. Miotto, Redford, MI (US)

(73) Assignee: LEAR CORPORATION, Southfield, MI (US)

(21) Appl. No.: 13/307,667

(22) Filed: Nov. 30, 2011

(51) Int. Cl. B60N 2/48; A47C 7/38; B60N 2/60

(52) U.S. Cl. 297/220; 297/219.1; 297/391; 297/452.48

(57) ABSTRACT

A trim cover for a vehicle head restraint includes a three dimensional sheet conforming to the shape of a head restraint system component and a slot having a first side and a second side. The trim cover also includes a two-way zipper closeout. The two-way zipper closeout includes a first strip having a first plurality of zipper teeth and a second strip having a second plurality of zipper teeth. The zipper closeout includes a first slider contacting the first and second plurality of teeth such that movement in a first direction closes the zipper closeout and movement in a second direction opens the zipper closeout. Finally, the zipper closeout also includes a second slider contacting the first and second plurality of teeth such that movement in the first direction opens the zipper closeout and movement in the second direction closes the zipper closeout.

### BACKGROUND OF THE INVENTION

1. Field of the Invention

In at least one aspect, the present invention relates to covers for vehicle folding head restraints.

2. Background Art

Vehicular head restraints are mounted to passenger seats for use in vehicles to provide passenger head restraint. Well known conventional head restraints include a padded head restraint body covered with a flexible upholstery material, and extend above the back support region of a seat with the head restraint typically attached directly to the seat.

In some prior art head folding restraints, the folding head restraint includes a post for attaching the head restraint to a vehicle seat and a foam core. Foam cores are commonly made from polyester. A trim cover encases the foam core. Typically, these trim covers are formed from cloth fabric, vinyl, or leather. For aesthetic reasons, trim covers are usually formed into pouch-shaped structures by sewing panels together. A consideration for folding head restraint designs is the passage of the post from the foam core through the trim cover. In one prior art design, open slots are provided for passage of the posts. In such circumstances, the foam core is usually visible causing an unappealing visual effect. In other prior art designs, a bezel is utilized to cover openings. This latter design adds extra costs and assembly considerations. Moreover, such bezel designs tend to lead to gaps that may result in finger pinching.

Accordingly, there exists a need for improved trim covers for head restraint assemblies that deal with the passage of head restraint posts.

### SUMMARY OF THE INVENTION

The present invention solves one or more problems of the prior art by providing a trim cover for a vehicle head restraint. The trim cover includes a three dimensional sheet conforming to the shape of a head restraint system component (e.g., a head restraint and/or seat back) and a slot having a first side and a second side. The trim cover also includes a two-way zipper closeout. The two-way zipper closeout includes a first strip having a first plurality of zipper teeth and a second strip having a second plurality of zipper teeth. The first strip is attached to the first side of the slot while the second strip is attached to the second side of the slot. The zipper closeout includes a first slider contacting the first and second plurality of teeth such that movement in a first direction closes the zipper closeout and movement in a second direction opens the zipper closeout. Finally, the zipper closeout also includes a second slider contacting the first and second plurality of teeth such that movement in the first direction opens the zipper closeout and movement in the second direction closes the zipper closeout. Characteristically, the first slider and the second slider are positionable such that a post opening is defined to allow passage of a head restraint post.

In another embodiment, a head restraint incorporating the trim cover set forth above is provided. The head restraint includes a head restraint cushion, a post extending from the head restraint cushion, and a trim cover disposed over the head restraint cushion. The trim cover includes a three dimensional sheet conforming to the shape of a head restraint cushion and a slot having a first side and a second side. The trim cover also includes a two-way zipper closeout. The two-way zipper closeout includes a first strip having a first plurality of zipper teeth and a second strip having a second plurality of zipper teeth. The first strip is attached to the first side of the slot while the second strip is attached to the second side of the slot. The zipper closeout includes a first slider contacting the first and second plurality of teeth such that movement in a first direction closes the zipper closeout and movement in a second direction opens the zipper closeout. Finally, the zipper closeout also includes a second slider contacting the first and second plurality of teeth such that movement in the first direction opens the zipper closeout and movement in the second direction closes the zipper closeout. Characteristically, the first slider and the second slider are positioned such that a post opening is defined to allow passage of a head restraint post.

Advantageously, the two-way zipper closeout set forth above leads to an aesthetically appealing appearance when integrated into a head restraint. The zipper closeout hides the core foam while holding it securely in place. Moreover, this design obviates the need for a bezel and reduces the risk of finger pinching.

### BRIEF DESCRIPTION OF THE DRAWINGS

Exemplary embodiments of the present invention will become more fully understood from the detailed description and the accompanying drawings, wherein:

FIG. 1A is a perspective view of a section of a head restraint having a two-way zipper closeout;

FIG. 1B is a side view of a head restraint showing position of a head restraint in the folded and upright position;

FIG. 1C is a perspective view of a head restraint having two posts and two zipper closeouts;

FIG. 2 is a front view of a section of a trim cover having a two-way close out;

FIG. 3 is a perspective view of a head restraint incorporating two zipper closeouts;

FIG. 4 is a top view of the coupler for holding the zipper sliders in place;

FIG. 5 is a top view of the coupler attached to the zipper closeout on the backside of the trim cover;

FIG. 6 is a perspective view of a front side coupler used attaching to the sliders;

FIG. 7 is a perspective view of a housing covering the front side coupler of FIG. 6; and

FIG. 8 is a perspective view of a seat back incorporating two way zipper closeouts with movement between a folded and upright position.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating are to be understood as modified by the word “about” in describing the broadest scope of the invention. Practice within the numerical limits stated is generally preferred. Also, unless expressly stated to the contrary: the description of a group or class of materials as suitable or preferred for a given purpose in connection with the invention implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

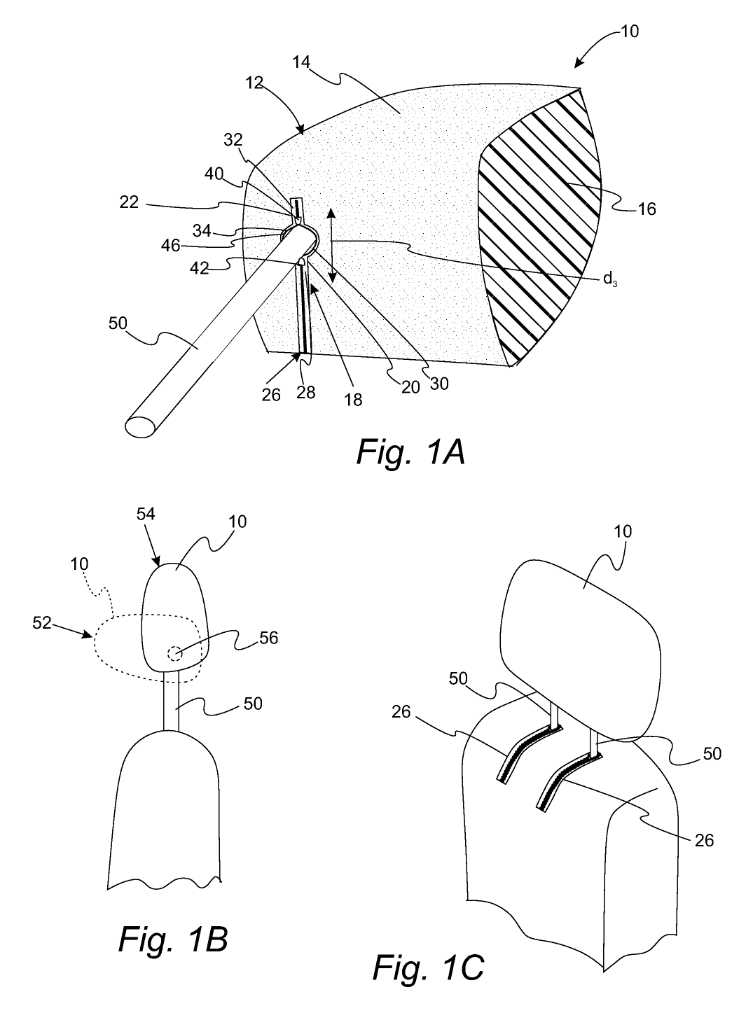

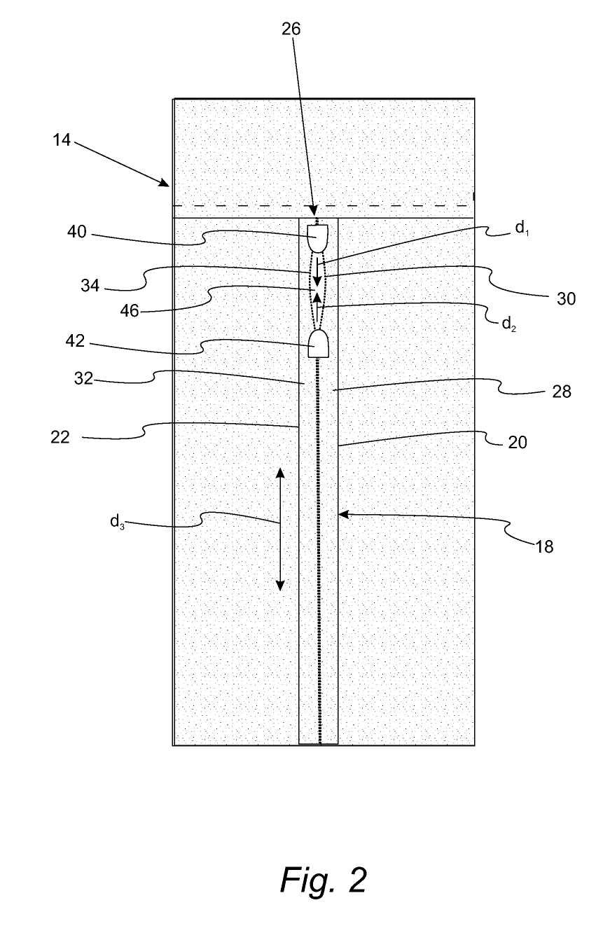

With reference to FIGS. 1A, 1B, 1C, and 2, schematic illustrations of a trim cover for a vehicle head restraint are provided. FIG. 1A is a perspective view of a section of a head restraint having a two-way zipper closeout and a head restraint post. FIG. 1B is a side view of a head restraint showing position of a head restraint in the folded and upright position. FIG. 1C is a perspective view of a head restraint having two posts and two zipper closeouts. FIG. 2 is a front view of a portion of the trim cover. Head restraint 10 includes cover 12. Cover 12 includes three dimensional sheet 14 conforming to the shape of head restraint cushion 16. Sheet 14 includes slot 18 which has first side 20 and second side 22. In a refinement, slot 18 is from about 4 to 5 inches. Cover 12 also includes two-way zipper closeout 26. Two-way zipper closeout 26 includes first strip 28 having first plurality 30 of zipper teeth and second strip 32 having second plurality 34 of zipper teeth. First plurality 30 of zipper teeth is attached first side 20 of slot 18. Second strip 32 is attached to second side 22 of slot 18. In combination, first strip 28 and second strip 32 form a two-way zipper closeout. In a refinement, first strip 28 and second strip 32 are sewn to sheet 14.

Still referring to FIG. 1A, 1B, 1C, and 2, zipper closeout 26 includes first slider 40 which contacts first plurality 30 of zipper teeth and second plurality 34 of zipper teeth such that movement in first direction d₁ closes the zipper closeout and movement in second direction d₂ opens zipper closeout 26. Zipper closeout 26 includes second slider 42 which contacts first plurality 30 of zipper teeth and second plurality 34 of zipper teeth such that movement in first direction d₁ opens the zipper closeout and movement in second direction d₂ closes zipper closeout 26. In a refinement, zipper closeout 26 closes by first plurality 30 of zipper teeth and second plurality 34 of zipper teeth interlocking First slider 40 and second slider 42 are positionable to define post opening 46 to allow passage of head restraint post 50. In a refinement when head restraint 12 is a forward or rearward folding head restraint, sliders 40 and 42 are able to move in a coordinated fashion along direction d₃ via a coupler such that the opening through which the post passes adjusts to the repositioning of the posts. FIG. 1B illustrates positioning of heat restraint 12 in folded position 52 and upright position 54 about axis 56.

In a variation of the present embodiment, first plurality 30 of zipper teeth and second plurality 34 of zipper teeth each independently comprise a metal. In another variation, first plurality 30 of zipper teeth and second plurality 34 of zipper teeth each independently comprise a component selected from the group consisting of plastics, nylons, and combinations thereof.

Still referring to 1A, 1B, 1C, and 2, sheet 14 may be made of any material suitable for a head restraint trim cover. Such materials include, but are not limited to, a woven or non-woven fabric, leather, plastics (e.g., vinyl), and the like.

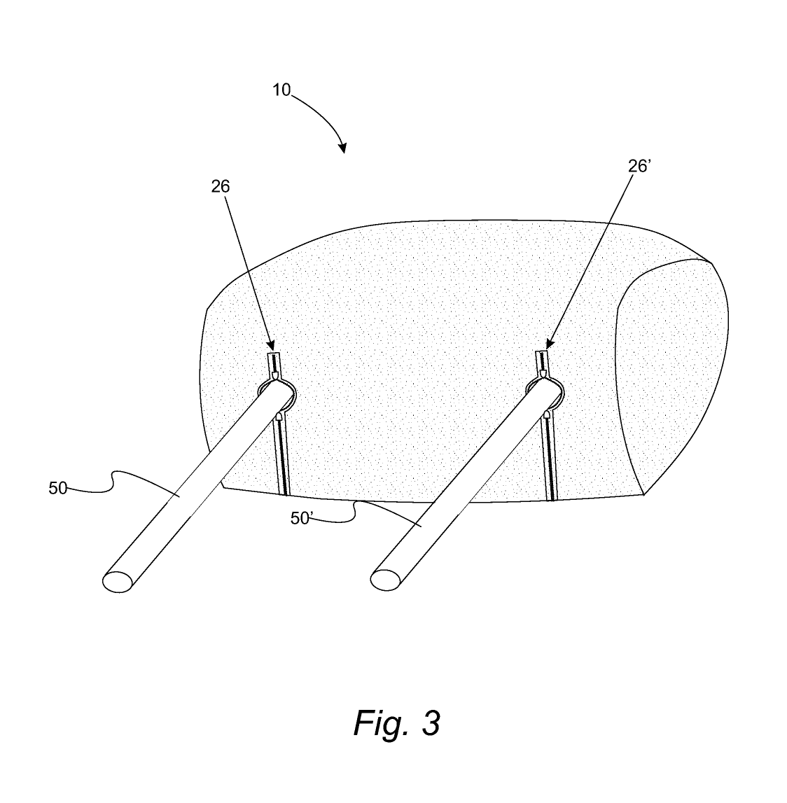

With reference to FIG. 3, a schematic illustration of a head restraint incorporating the closeouts set forth above is provided. FIG. 3 is a perspective view of a head restraint having a pair of two-way zipper closeouts and a pair of head restraint posts. In this variation, head restraint 10 includes zipper closeouts 26 and 26′ each of which is of the design depicted in FIGS. 1 and 2. Head restraint 10 includes head restraint posts 50 and 50′. In a refinement, head restraint 10 is a rear folding or forward folding head restraint.

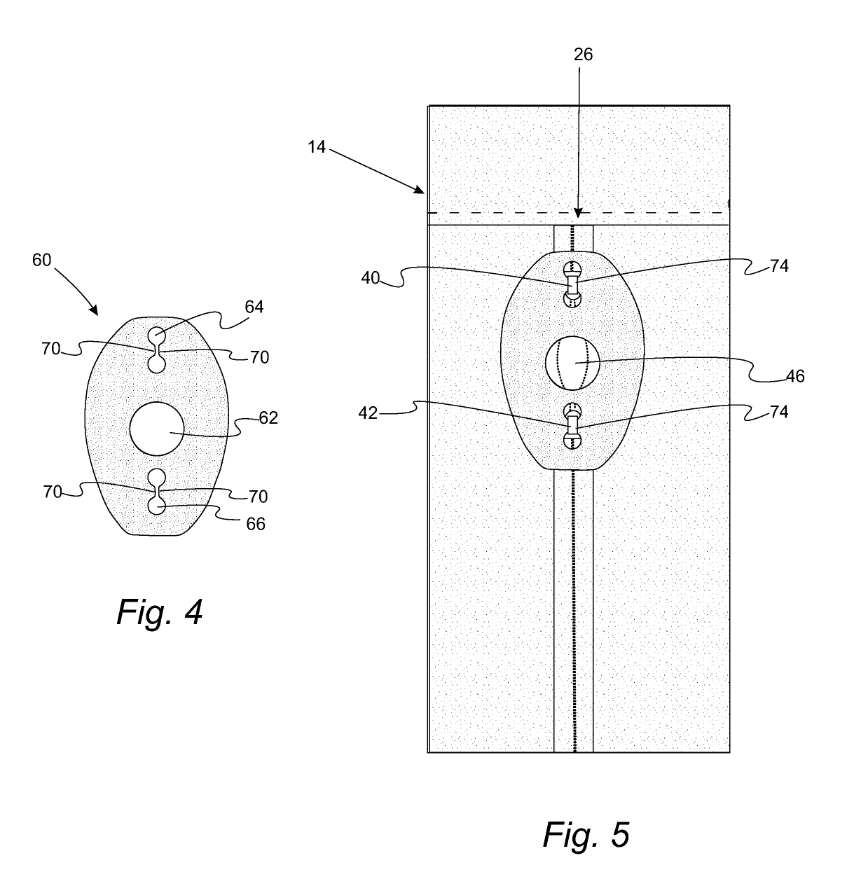

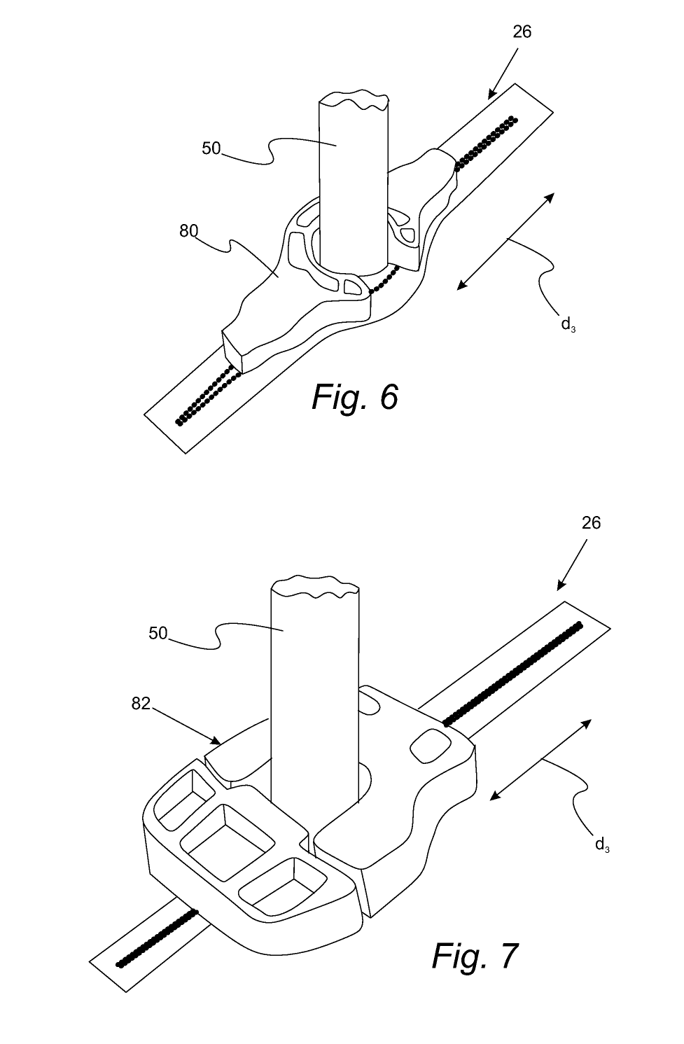

With reference to FIGS. 4 and 5, schematics illustrating the function of a backside coupler is provided. FIG. 4 is a top view of the backside coupler. FIG. 5 is a top view of the coupler attached to the zipper closeout on the backside (i.e., the B side) of the trim cover. Backside coupler 60 holds first slider 40 and second slider 42 in a position defining the post opening 46. In a refinement, backside coupler 60 includes central opening 62 as well as dumbbell-shaped openings 64, 66. Dumbbell-shaped openings 64, 66 include indentations 70 which assist in immobilizing first slider 40 and second slider 42 by catching extension 74 in the sliders. For this purpose, extension 74 may include a notch or hole. Typically, coupler 60 is formed from a rigid or semi-rigid plastic or thin metal sheet.

With reference to FIGS. 6 and 7, schematic illustrations of a front side couple used in various embodiment of the invention are provided. FIG. 6 is a perspective view of he front side coupler used attaching to the sliders. FIG. 7 is a perspective view of a housing covering the front side coupler of FIG. 6. Post 50 emerges from two way closeout 26. Front side coupler 80 contacts first slider 40 and second slider 42. Housing 82 surrounds front side coupler 80. In a refinement such as foldable head restraints, front side coupler 80 allows for first slider 40 and second slider 42 to move in unison when post 50 is moved from an open to closed head restraint position.

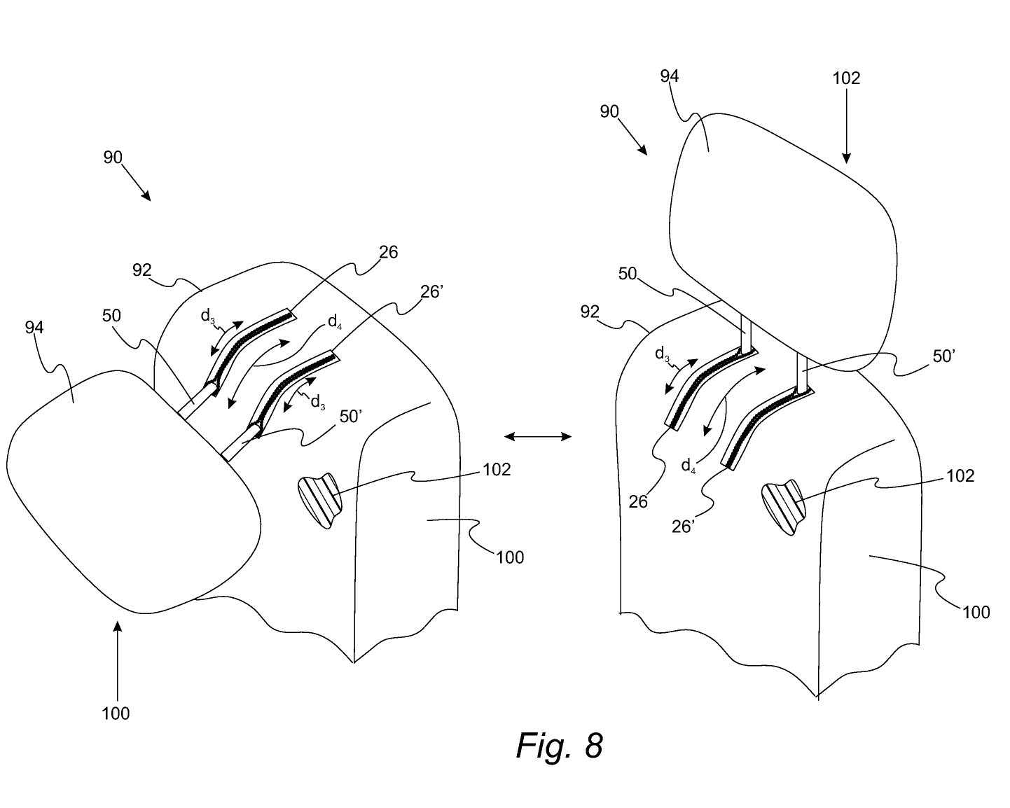

With reference to FIG. 8, a perspective view of a seat back incorporating two way zipper closeouts with movement between a folded and upright position is provided. FIG. 8 shows a head restraint in the folded position with a portion of the trim cover removed to reveal the cushion. Head restraint system 90 includes seat back 92 and head restraint 94. Head restraint 94 is coupled to seat back 92 by methods well known to those skilled in the art. Seat back 94 includes trim cover 100 which covers seat back cushion 102. Seat back 94 also includes two way zipper closeout 26, 26′ which as described in more detail with respect to the descriptions of FIGS. 1-7. In refinement, as head restraint 94 moved from a folded position 100 to upright position 102 along direction d₄, the position of the sliders in zipper closeout 26 move in a concerted fashion along direction d₃ such that the opening through which the posts passes adjust to the repositioning of the posts. As set forth above front and/or back side couplers may be used for this purpose.

In another embodiment, the designs set forth above are applied to a recliner. In this embodiment, the three dimensional sheet conforms to a recliner headrest.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A cover for a vehicle head restraint, the cover comprising:
a three dimensional sheet conforming to the shape of a head restraint system component, the sheet including a slot having a first side and a second side;
a two-way zipper closeout including:
a first strip having a first plurality of zipper teeth, the first strip being attached to the first side of the slot;
a second strip having a second plurality of zipper teeth, the second strip being attached to the second side of the slot;
a first slider contacting the first plurality of zipper teeth and second plurality of zipper teeth such that movement in a first direction closes the zipper closeout and movement in a second direction opens the zipper closeout;
a second slider contacting the first plurality of zipper teeth and second plurality of zipper teeth such that movement in the first direction opens the zipper closeout and movement in the second direction closes the zipper closeout, wherein the first slider and the second slider are positionable such that a post opening is defined to allow passage of a head restraint post.

2. The cover of claim 1 further comprising a coupler that holds the first slider and the second slider in a position defining the post opening.

3. The cover of claim 1 wherein the sheet comprises a woven fabric, a non-woven fabric, or a plastic

4. The cover of claim 1 wherein the first slider and second slider are moveable in a coordinate manner.

5. The cover of claim 1 wherein head restraint system component is a head restraint.

6. The cover of claim 1 wherein head restraint system component is a seat back.

7. The cover of claim 1 further comprising a second two-way zipper closeout.

8. The cover of claim 1 wherein the first plurality of teeth and the second plurality of teeth each independently comprise a component selected from the group consisting of metals, plastics, nylons, and combinations thereof.

9. The cover of claim 1 wherein the zipper closeout closes by the first plurality of teeth and the second plurality interlocking.

10. A head restraint comprising:
a head restraint cushion;
a first post extending from the head restraint cushion; and
a cover disposed over the head restraint cushion, the cover comprising:
a three dimensional sheet conforming to the shape of a head restraint cushion, the sheet including a slot having a first side and a second side; and
a two-way zipper closeout including:
a first strip having a first plurality of zipper teeth, the first strip being attached to the first side of the slot;
a second strip having a second plurality of zipper teeth, the second strip being attached to the second side of the slot, the first and second strips forming a zipper closeout;
a first slider contacting the first and second plurality of teeth such that movement in a first direction closes the zipper closeout and movement in a second direction opens the zipper closeout;
a second slider contacting the first and second plurality of teeth such that movement in the first direction opens the zipper closeout and movement in the second direction closes the zipper closeout, wherein the first slider and the second slider are positionable such that a post opening is defined to allow passage of the post.

11. The head restraint of claim 10 further comprising a second post extending from the head restraint cushion.

12. The head restraint of claim 11 further comprising a second zipper closeout through which the second post passes.

13. The head restraint of claim 10 further comprising a coupler that holds the first slider and the second slider in a position defining the post opening.

14. The head restraint of claim 10 wherein the first slider and second slider are moveable in a coordinate manner.

15. The head restraint of claim 10 wherein the sheet comprises a woven fabric, a non-woven fabric, or a plastic.

16. The head restraint of claim 10 wherein the first plurality of teeth and the second plurality of teeth each independently comprise a component selected from the group consisting of metal, plastics, nylons, and combinations thereof.

17. The head restraint of claim 10 wherein the zipper closeout closes by the first plurality of teeth and the second plurality interlocking.

18. The head restraint of claim 10 wherein the head restraint is a folding head restraint.

19. A seat back comprising:
a seat back cushion;
a first post extending from the seat back cushion; and
a cover disposed over the seat back cushion, the cover comprising:
a three dimensional sheet conforming to the shape of a seat back cushion,
the sheet including a slot having a first side and a second side; and
a two-way zipper closeout including:
a first strip having a first plurality of zipper teeth, the first strip being attached to the first side of the slot;
a second strip having a second plurality of zipper teeth, the second strip being attached to the second side of the slot, the first and second strips forming a zipper closeout;
a first slider contacting the first and second plurality of teeth such that movement in a first direction closes the zipper closeout and movement in a second direction opens the zipper closeout;
a second slider contacting the first and second plurality of teeth such that movement in the first direction opens the zipper closeout and movement in the second direction closes the zipper closeout, wherein the first slider and the second slider are positionable such that a post opening is defined to allow passage of the post.

20. The seat back of claim 19 wherein the first slider and second slider are moveable in a coordinate manner.
